(19) United States
(12) Patent Application Publication
(10) Pub. No.: US 2015/0095245 A1
(43) Pub. Date: Apr. 2, 2015

(54) Method for Increasing Regulatory Compliance of a Company with Integrated Training and Hardware Service

(71) Applicant: Robert Daniel Cowan, Harrison Township, MI (US)

(72) Inventor: Robert Daniel Cowan, Harrison Township, MI (US)

(21) Appl. No.: 14/502,604

(22) Filed: Sep. 30, 2014

Related U.S. Application Data
(60) Provisional application No. 61/885,948, filed on Oct. 2, 2013.

(51) Int. Cl. G06Q 30/00

(52) U.S. Cl. CPC G06Q 30/018
USPC 705/317

(57) ABSTRACT

An Information technology (IT) company supplies a hardware service, a software service, and a bandwidth service for a client company so that a compliance posture of the client company can be completed. The IT company maintains the supplied compliance posture for a duration of a designated time period and then conducts a period evaluation for the client company. Then the IT company is able to identify at least inefficiency about the client company from the period evaluation so that the IT company is able to address the at least one inefficiency with a solution plan as the solution plan is implemented through an execution procedure. As a result, the IT company is able to improve the compliance posture of the client company through the solution plan.

The current application claims a priority to the U.S. Provisional Patent application Ser. No. 61/885,948 filed on Oct. 2, 2013.

### FIELD OF THE INVENTION

The present invention relates generally to a method for a business process. More specifically, the present invention is a method for increasing regulatory compliance of a company with integrated training and personnel services.

### BACKGROUND OF THE INVENTION

Evolvement of the modern technology causes companies to purchase and implement Information Technology (IT) related hardware, software, and bandwidth service. The IT related hardware is the physical elements within a company that can include, but not limited to, personal computers, printers, scanners, servers routers, phones, and modems. The software is any set of machine-readable instruction that directs a computer processor to perform specific operation such as, antivirus programs, office suite desktop applications, computer aid design programs, media application and other computer based applications. The bandwidth service normally represents the different communication system of the company such as phone plans and internet plans. As a collection, the IT related hardware, software, and bandwidth service enables a company to efficiently operate while identifying gaps within the business model and technology process of the respective company. Most of these products and services have yearly renewals or maintenance associated with their continued use and/or support. Even though most the companies utilize these products and services, it is often too difficult for companies to effectively keep up with updates and new technologies that are related to these products and services in daily bases. As a result, most companies fall behind with the IT related hardware, the software, and the bandwidth service overtime, essentially devaluing the company.

It is therefore an object of the present invention to introduce a method and process for purchasing and distributing software and hardware with integrated training and personnel services. The present invention not only initially meets and maintains the compliance posture of the company, but also provide an additional hardware service, an additional software service, an additional bandwidth service, or a combination thereof to improve the compliance posture of the company.

### BRIEF DESCRIPTION OF THE DRAWINGS

FIG. 1 is a basic flow chart illustrating the overall method of the present invention.

FIG. 2 is a basic flow chart illustrating the initial compliance posture process within the overall method of the present invention.

FIG. 3 is a basic flow chart illustrating the identifying of the at least one inefficiency within the overall method of the present invention.

FIG. 4 is a basic flow chart illustrating the assessment of the solution plan within the overall method of the present invention.

FIG. 5 is a basic flow chart illustrating the different execution procedures within the overall method of the present invention.

FIG. 6 is a basic flow chart illustrating the solution plan applying process within the overall method of the present invention.

### DETAIL DESCRIPTIONS OF THE INVENTION

All illustrations of the drawings are for the purpose of describing selected versions of the present invention and are not intended to limit the scope of the present invention.

The present invention is a method for increasing the compliance services of a company with integrated training and hardware service. The present invention is implemented by an information technology (IT) company that provides a hardware service, a software service, and a bandwidth service so that the IT company can meet a compliance posture of a client company through the hardware service, the software service, and the bandwidth service. Even though the present invention is described in relation to a single client company, the same exact method can be implemented for multiple client companies. The compliance posture of the client company can range from a regulatory and compliance service, an application security service, a technology solution service, a mobile security service, a security transformation service, a risk assessment service, a trusted scan service, a computer forensics service, and a bug sweeping service as the IT company is able to provide any combination thereof to the client company depending on the specific requirements of the client company.

The regulatory and compliance service normally assists the client company to achieve and ensure the expectations set by the client company as the IT company is able to provide the regulatory and compliance service according to the following categorizes including, but are not limited to:
gap analysis of Payment Card Industry Data Security Standard (PCI DSS)
assist in health care information protection according to the Health Insurance Portability and Accountability Act (HIPAA) and The Health Information Technology for Economic and Clinical Health Act (HITECH)
security for energy companies according to the Critical infrastructure protection (CIP)
gap analysis assessment for TR-39, which is the standard required by all organizations that accept debit cards
help identify potential flaws within the overall program or around documentation while providing assist for the Federal Financial Institutions Examination Council (FFIEC) examination
assist in validating the Service Organization Control (SOC) report and ensure they are appropriate and/or help to restructure the framework to ensure adequate protections for services organizations

The application security service provides a combination of manual testing, source code analysis, and dynamic testing in identifying exposures within applications of the client company. The IT company preferably categorizes the application security assessments in three different methodologies. The first method utilizes mostly automated scanning with manual identification, verification, and exploitation in order to identify insecure configurations of the applications and exposures of a respective website. The first method can be performed without having a deep understanding about the applications and without accessing the source codes of the applications and the website. The second method utilizes about 90% manual effort and about 10% automated effort to perform an in-depth assessment of the applications and exposures of the respective website. The IT company manually reviews the applications to identify potential exposures that pure source code audits have difficulty finding. The third method is a pure source code audit of the applications while identifying the exposures of the respective website. The IT company takes significant precautions when performing source code assessments due to the sensitive nature of the applications. The applications are inspected line by line and reviewed to ensure proper controls are in place to protect the applications. An automated source code analysis tools and a manual review create a comprehensive approach in identifying the exposures of the applications and the respective website.

The technology solution service provides important functions when the client company is looking to expand by utilizing technology. The IT company works with the client company to identify the best fit for the client company and help assist in developing the technology around an infrastructure and architecture. The IT company also performs implementation assistance along with validation and testing to ensure the technology solutions are completed correctly.

The mobile security service can be utilized to provide the protection around devices and applications that are developed and used in day to day business use. The IT company ensures that proper controls are in place on mobile device platforms and how mobile applications are developed since the protection of these mobile devices are essential to the client company. More specifically, the IT company assists in selecting, deploying, and securing mobile solutions and associated architecture for the client company. Then the IT company works with the client company to find the best solution and deployment strategies possible. A comprehensive review is performed for the identification of requirements in order to effectively design, augment, and test the infrastructure of the client company. If the solution and architecture already exist within the client company, the IT company can validate the implementation and security around the existing solution and architecture. Due to the excessive usage of custom mobile applications, the client company can face a number of security concerns and vulnerabilities along the usage of the custom mobile applications. Therefore, the IT company performs both dynamic and source code analysis to identify any security concerns and vulnerabilities that may be associated with the custom mobile applications.

The security transformation service provided by the IT company is able to includes several sub programs that dictates different level of maturity for individual programs of the client company. Then the IT company can build an overall program within the client company so that the overall program is able to ensure the maturity model meet its acceptable levels and standards along the accomplishments of the client company.

The risk assessment service provides the proper understanding about current maturity of the client company in relation to twelve different domains. Understanding of these twelve different domains is vital for the security transformation service of the client company. The IT company takes a blended approach by performing a series of interviews regarding the twelve different domains of the security transformation service. Then the IT company performs validation and testing to ensure that the actual maturity level is at the correct level according to the following twelve different domains:
Policies and procedures
Regulatory and compliance
Network and telecommunication security
Application security
Hardening guidelines
External presence
Incident response
Monitoring and detection
Third party vendor management
Wireless and mobile security
Education awareness
Physical security

The trustedscan service is an automated scanning solution that can be performed against the client company at any interval that is requested by the client company, wherein the interval can include, but not limited to, monthly, quarterly, and annually. The automated scanning is conducted by the IT company to identify pre-defined exposures or vulnerabilities. After the trustedscan service completes a vulnerability report, the IT company manually validates the vulnerability report to eliminate the amount of false positive of the vulnerability report. Then the vulnerability report is automatically delivered to the client company. The trustedscan service is all inclusive of all the layers of security including the network, operating system, and web application layers. Different levels of validation can be performed to the vulnerability report upon request from the client company. For example, The IT company can manually validate all the findings before giving the vulnerability report to the client company. However, the IT company can also deliver just the vulnerability report without manually validating the findings.

The IT company can perform incident response assistance in a number of scenarios in reference to the computer forensic service. Regardless of a disgruntled employee, malicious insider, hackers, a large-scale breach, or need assistance as an expert witness for litigation support; The IT company helps the client company in ensuring the damages are minimized as the IT company utilizes industry accepted and top of class hardware and software for performing incident response to ensure quick and accurate results. More specifically, the techniques used by the IT company hold up in a court of law and ensure appropriate chain of custody and the highest quality of standards as they ensure the following:
Admissible evidence into litigation scenarios
Proper handling of evidence with rapid discovery and acquisition
Clear and concise results around what was discovered
Senior level resources assigned to the project
Litigation support and assistance during court cases
Electronic Discovery (e-Discovery) for ongoing litigation

The IT company performs Technical Surveillance Counter-Measure (TSCM) assessments for the client company that is looking to identify potentially unauthorized tapping devices or hidden cameras. The IT company utilizes industry grade detection tools in finding any type of bug, tap, hidden camera, or unauthorized devices while performing the TSCM assessment:
Perform a sweep of all analog, digital, and out of band frequency ranges. The sweeps are conducted at the 10 MHz to the 8 GHz spectrum frequency ranges. This allows the IT company to detect and locate any bug device that may be present.
Telephone tap detection, which detects illegal, phone bridging and wire tap hardware that can intercept voice calls. This also includes the investigation of computer and fax inline tapping equipment.
Laser tapping which is primarily used by law enforcement however can still be used via the private sector. Laser tapping utilizes a laser beam that bounces off the glass, the sound vibrations are then captured and can be heard from long distances away.
Hidden camera detection using high powered reflected light to identify the presence of hidden cameras in the building.

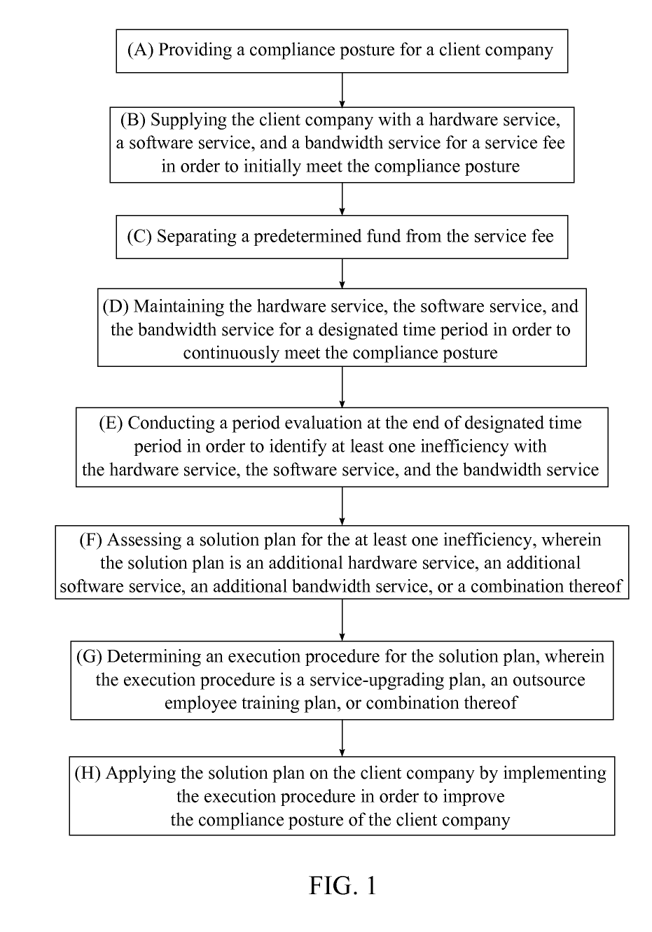

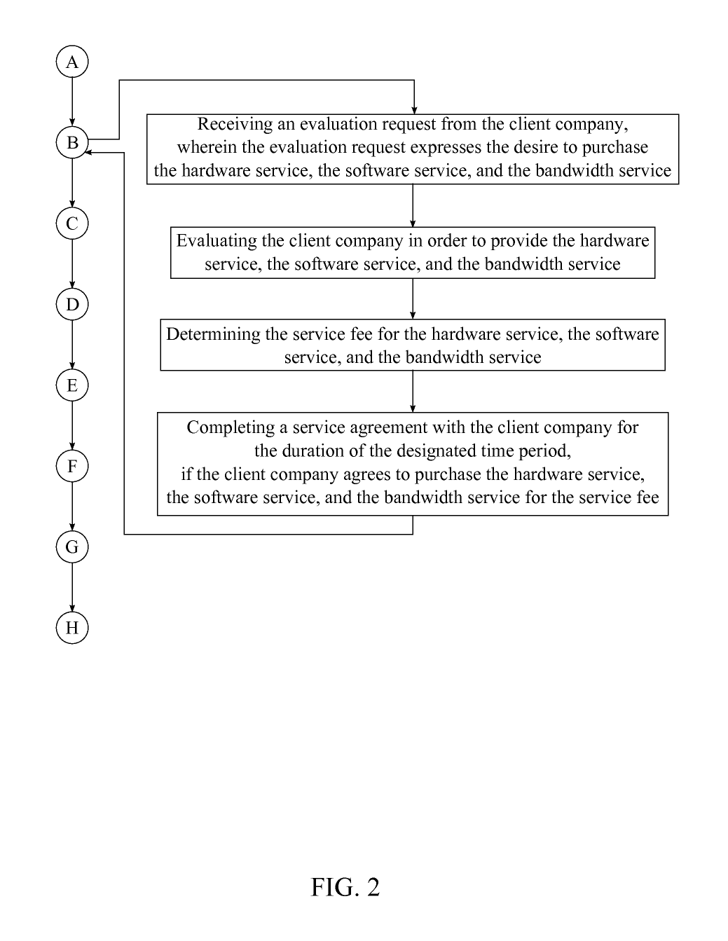

In reference to FIG. 1, to initiate the present invention, the IT company supplies the hardware service, the software service, and the bandwidth service to the client company so that the compliance posture of the client company can be initially completed by the IT company. As shown in FIG. 2, the TI company receives an evaluation request form the client company as the evaluation request expresses the desire to purchase the hardware service, the software service, and the bandwidth service. Then the IT company evaluates the client company in order to provides the necessary hardware service, the software service, and the bandwidth service. The evaluation can be carried out as an onsite evaluation or an offsite evaluation upon the request of the client company or the complexity of the compliance posture. For example, if the client company requests the onsite evaluation, the IT company conducts the onsite evaluation for the compliance posture of the client company. However, if the IT company decides that the offsite evaluation is sufficient enough and the client company does not request the onsite evaluation, the IT company conducts the offsite evaluation for the compliance posture of the client company. Once the evaluation is completed by the IT company, the IT company determines a service fee for the hardware service, the software service, and the bandwidth service so that a service agreement can be presented to the client company. Then the IT company completes the service agreement with the client company if the client company agrees to purchase the hardware service, the software service, and the bandwidth service from the IT company. The service agreement generally extends for a designated time period as the IT company and the client company agree upon the service fee that coated by the IT company for the hardware service, the software service, and the bandwidth service. The IT company determines the service fee through the evaluation of the client company as the service fee directly correlates with the hardware service, the software service, and the bandwidth service. The designated time period is generally requested from the client company upon requirements of the client company and can be any duration of time period, such as one year, two years, and three years.

In reference to FIG. 1, then the IT company separates a predetermined fund from the service fee, wherein the predetermined fund is a specific percentage or amount from the service fee and strictly determined upon the preference of the IT company. For example, the IT company can decide to allocate 10% of the service fee as the predetermined fund.

In reference to FIG. 1, once the IT company supplies the hardware service, the software service, and the bandwidth service to the client company, the IT company maintains the hardware service, the software service, and the bandwidth service for the designated time period in order to continuously meet the compliance posture of the client company. More specifically, the client company receives continuous a consulting service in addition to a management service, an administer service, and a technical service for the hardware service, the software service, and the bandwidth service.

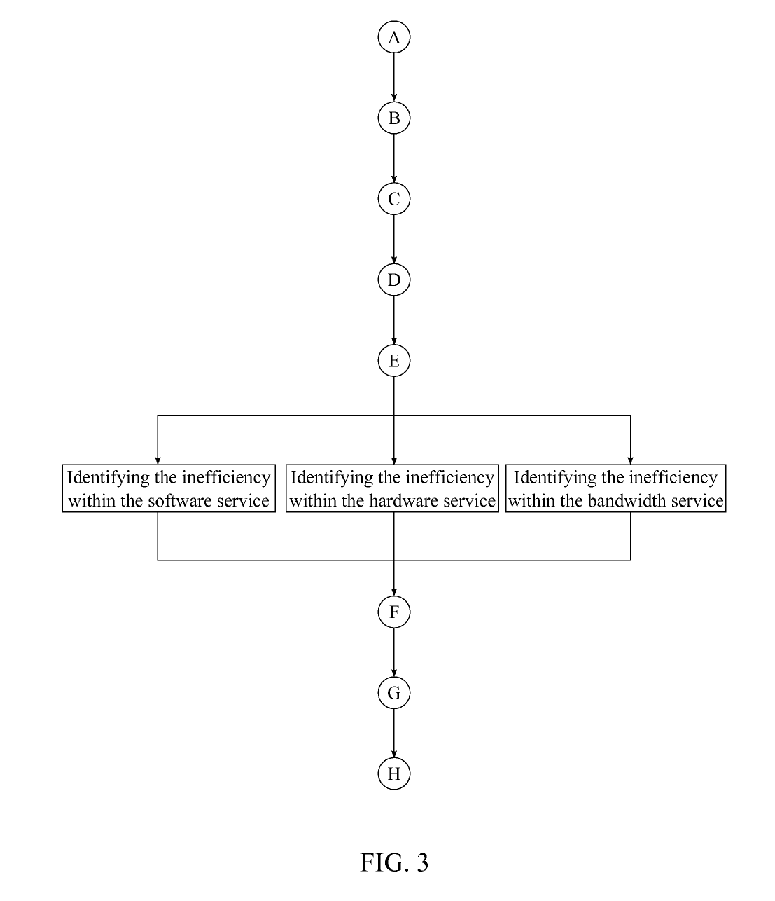

In reference to FIG. 1 and FIG. 3, at the end of the designated time period, the IT company conducts a period evaluation in order to identify at least one inefficiency with the hardware service, the software service, and the bandwidth service of the client company. More specifically, the IT company realizes that the client company is bound to change over the designated time period due to many different variables including, but are not limited to, company expansions, staff changes, new technology, and increasing business. These variables determine outcome for the compliance posture of the client company as the initially supplied compliance posture may not be sufficient enough for the client company to efficiently operate within the competitive business environment. More specifically, the IT company is able to identify the at least one inefficiency as followed; the IT company identifies the at least one inefficiency within the hardware service, if the hardware service has displayed at least one inefficiency for the client company during the designated time period. Similarly, the IT company individually identifies the at least one inefficiency within the software service and the bandwidth service, if the software service and the bandwidth service have displayed at least one inefficiency for the client company during the designated time period.

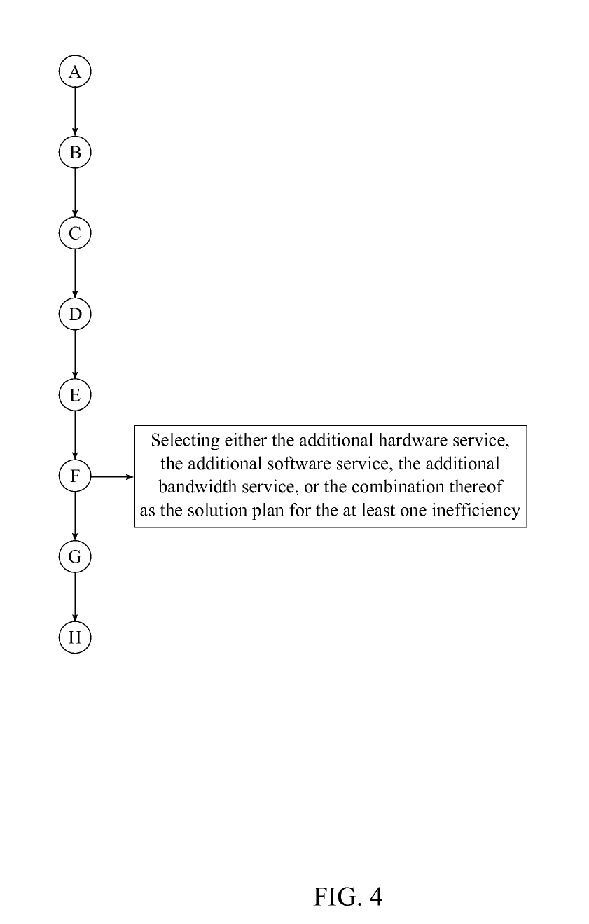

In reference to FIG. 4, then the IT company assesses a solution plan for the at least one inefficiency so that the client company can be brought up to the competitive standards of the respective business field. In order to properly address the at least one inefficiency of the client company, the solution plan can be categorized into an additional hardware service, an additional software service, an additional bandwidth service, or a combination of thereof. The IT company is able to select the correct and necessary solution plan for the client company so that the at least one inefficiency can be addressed and corrected through the solution plan.

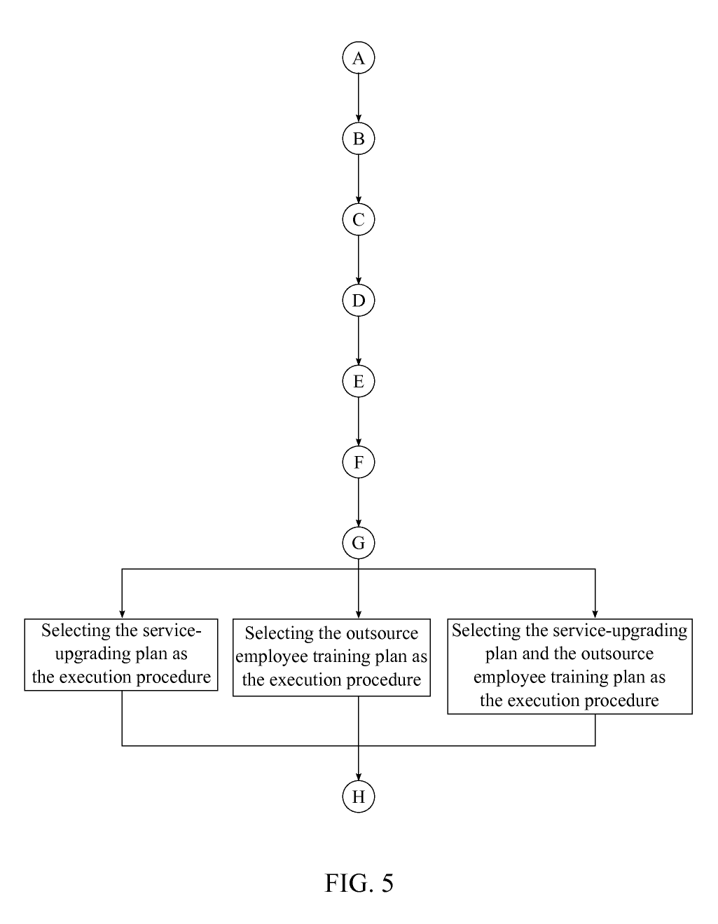

In reference to FIG. 1 and FIG. 5, once the solution plan is assessed by the IT company, the IT company determines an execution procedure for the solution plan. The solution plan can be implemented into the client company from one of the following three different plans, wherein the three different plans are a service-upgrading plan, an outsource employee training plan, or a combination thereof. More specifically, the IT company first selects the additional hardware service, the additional software service, the additional bandwidth service, or the combination thereof as the solution plan for the at least one inefficiency. Then the service-upgrading plan can be selected as the execution procedure if the service-upgrading plan is able to solve the at least one inefficiency of the client company. If the IT company decides that the at least one inefficiency can be solved by utilizing the outsource employee training plan, the IT company selects the outsource employee training plan as the execution procedure. Similarly, if the IT company decides that the at least one inefficiency can be solved by utilizing the service-upgrading plan and the outsource employee training plan, the IT company selects the service-upgrading plan and the outsource employee training plan as the execution procedure.

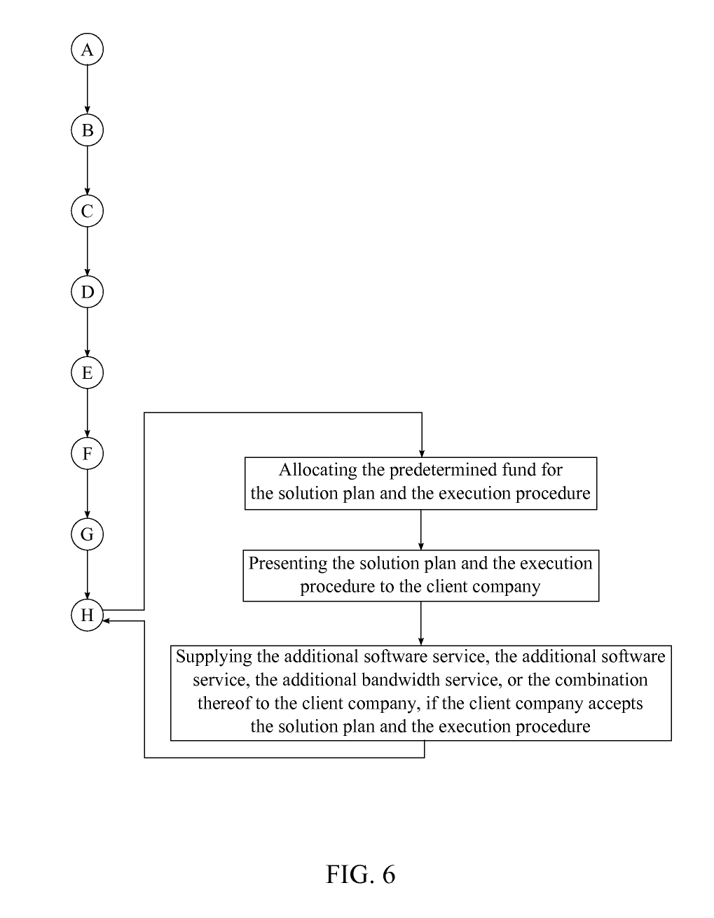

In reference to FIG. 6, then the solution plan is applied to the client company through the implementation of the execution procedure so that the compliance posture of the client company can be improved. More specifically, the IT company allocates the predetermined fund for the solution plan and the execution procedure so that the IT company is able to present the solution plan and the execution procedure to the client company. Then the additional hardware service, the additional software service, the additional bandwidth service, or the combination thereof can be supplied to the client company, if the client company accepts the solution plan and the execution procedure.

Although the invention has been explained in relation to its preferred embodiment, it is to be understood that many other possible modifications and variations can be made without departing from the spirit and scope of the invention as hereinafter claimed.

What is claimed is:

1. A method for increasing compliance services of a company with integrated training and hardware service comprises the steps of:
providing a compliance posture for a client company;
supplying the client company with a hardware service, a software service, and a bandwidth service for a service fee in order to initially meet the compliance posture;
separating a predetermined fund from the service fee;
maintaining the hardware service, the software service, and the bandwidth service for a designated time period in order to continuously meet the compliance posture;
conducting a period evaluation at the end of designated time period in order to identify at least one inefficiency with the hardware service, the software service, and the bandwidth service;
assessing a solution plan for the at least one inefficiency, wherein the solution plan is an additional hardware service, an additional software service, an additional bandwidth service, or a combination thereof;
determining an execution procedure for the solution plan, wherein the execution procedure is a service-upgrading plan, an outsource employee training plan, or combination thereof; and
applying the solution plan on the client company by implementing the execution procedure in order to improve the compliance posture of the client company.

2. The method for increasing compliance services of a company with integrated training and hardware service claimed in claim 1 comprises the steps of:
receiving an evaluation request from the client company, wherein the evaluation request expresses the desire to purchase the hardware service, the software service, and the bandwidth service;
evaluating the client company in order to provide the hardware service, the software service, and the bandwidth service;
determining the service fee for the hardware service, the software service, and the bandwidth service; and
completing a service agreement with the client company for the duration of the designated time period,
if the client company agrees to purchase the hardware service, the software service, and the bandwidth service for the service fee.

3. The method for increasing compliance services of a company with integrated training and hardware service claimed in claim 1 comprises the steps of:
identifying the at least one inefficiency within the hardware service,
if the hardware service displays at least one inefficiency for the client company.

4. The method for increasing compliance services of a company with integrated training and hardware service claimed in claim 1 comprises the steps of:
identifying the at least one inefficiency within the software service,
if the software service displays at least one inefficiency for the client company.

5. The method for increasing compliance services of a company with integrated training and hardware service claimed in claim 1 comprises the steps of:
identifying the at least one inefficiency within the bandwidth service,
if the bandwidth service displays at least one inefficiency for the client company.

6. The method for increasing compliance services of a company with integrated training and hardware service claimed in claim 1 comprises the steps of:
selecting either the additional hardware service, the additional software service, the additional bandwidth service, or the combination thereof as the solution plan for the at least one inefficiency; and
selecting the service-upgrading plan as the execution procedure,
if the service-upgrading plan solves the at least one inefficiency of the client company.

7. The method for increasing compliance services of a company with integrated training and hardware service claimed in claim 1 comprises the steps of:
selecting either the additional hardware service, the additional software service, the additional bandwidth service, or the combination thereof as the solution plan for the at least one inefficiency; and
selecting the outsource employee training plan as the execution procedure,
if the outsource employee training plan solves the at least one inefficiency of the client company.

8. The method for increasing compliance services of a company with integrated training and hardware service claimed in claim 1 comprises the steps of:
selecting either the additional hardware service, the additional software service, the additional bandwidth service, or the combination thereof as the solution plan for the at least one inefficiency; and
selecting the service-upgrading plan and the outsource employee training plan as the execution procedure,
if the service-upgrading plan and the outsource employee training plan solve the at least one inefficiency of the client company.

9. The method for increasing compliance services of a company with integrated training and hardware service claimed in claim 1 comprises the steps of:
allocating the predetermined fund for the solution plan and the execution procedure;
presenting the solution plan and the execution procedure to the client company; and
supplying the additional software service, the additional software service, the additional bandwidth service, or the combination thereof to the client company,
if the client company accepts the solution plan and the execution procedure.
